(19) United States
(12) Patent Application Publication
(10) Pub. No.: US 2004/0121190 A1
(43) Pub. Date: Jun. 24, 2004

(54) Magnetic recording medium and magnetic storage apparatus using the same

(75) Inventors: Tsuyoshi Onuma, Moriya-shi (JP); Akira Yano, Moriya-shi (JP); Satoshi Matsunuma, Kamakura-shi (JP); Enji Fujita, Matsudo-shi (JP)

Correspondence Address: OLIFF & BERRIDGE, PLC, P.O. BOX 19928, ALEXANDRIA, VA, 22320, US

(73) Assignee: HITACHI MAXELL, LTD., IBARAKI-SHI (JP)

(21) Appl. No.: 10/725,421

(22) Filed: Dec. 3, 2003

(30) Foreign Application Priority Data
Dec. 4, 2002 (JP) 2002-351973

(51) Int. Cl. G11B 5/66

(52) U.S. Cl. 428/694 TS; 428/694 R

(57) ABSTRACT

A magnetic disk comprises, on a substrate, a soft magnetic layer, a seed layer, and a recording layer having an artificial lattice structure. The soft magnetic layer is formed of Co and B, and the seed layer is formed of Pd and B. The structure can reduce the magnetic exchange coupling force in the in-plane direction acting between crystal grains of the recording layer. Therefore, minute recording magnetic domains can be formed in the recording layer, the magnetization transition area is distinct, and the medium noise is reduced. Even when information is recorded at a high density, the information can be reproduced with low medium noise. The thermal stability is also excellent, because the recording layer composed of the artificial lattice structure has high magnetic anisotropy.

### BACKGROUND OF THE INVENTION

1. Field of the Invention

The present invention relates to a magnetic recording medium and a magnetic storage apparatus using the same. In particular, the present invention relates to a magnetic recording medium for recording a large amount of information quickly and correctly and reproducing the recorded information with low noise, and a magnetic storage apparatus based on the use of the same.

2. Description of the Related Art

In response to the progress of the advanced information society developed in recent years, the needs are notably increased for the realization of the large capacity and the high density of the information-recording apparatus. A magnetic storage apparatus is known as one of the information-recording apparatuses which respond to the needs. The magnetic storage apparatus is used as the large capacity storage apparatus, for example, for the large-sized server, the parallel type computer, the personal computer, the network server, the movie server, and the mobile PC. The magnetic storage apparatus comprises a magnetic recording medium on which information is recorded, and a magnetic head which is operable to record and reproduce the information recorded on the magnetic recording medium. The magnetic recording medium includes a ferromagnetic thin film which is composed of a cobalt alloy or the like and which is formed as a recording layer on a disk-shaped substrate, for example, by the sputtering method. A protective layer and a lubricant film are formed on the recording layer in order to enhance the sliding movement resistance and the corrosion resistance.

As the capacity of the magnetic storage apparatus is increased, it is intended to improve the recording density of the magnetic recording medium by recording minute recording magnetic domains in the recording layer of the magnetic recording medium. The attention is directed to the perpendicular magnetic recording system as a method for making the recording magnetic domains to be fine and minute. In the perpendicular magnetic recording system, the magnetic recording is performed by forming magnetic domains having the perpendicular magnetization in a recording layer by using a magnetic recording medium having the recording layer which exhibits the perpendicular magnetization. The recording density of the magnetic recording medium can be enhanced in the perpendicular magnetic recording system, because the minute magnetic domains can be formed in the recording layer.

A polycrystalline film based on Co—Cr has been hitherto used as a material to be used for the recording layer of the magnetic recording medium based on the perpendicular magnetic recording system. In the polycrystalline film, the two-phase separation structure is formed, which is composed of the ferromagnetic crystal grains having a high Co concentration and the non-magnetic crystal grain boundary having a high Cr concentration. The magnetic interaction between the ferromagnetic crystal grains can be blocked by the non-magnetic crystal grain boundary. Accordingly, it is possible to realize the low noise medium which is required for the high density recording.

In order to further improve the surface recording density of the magnetic recording medium, it is necessary to further reduce the medium noise. It has been revealed to be effective for this purpose that the magnetization reversal unit is made fine and minute and the reading head is made highly sensitive. In particular, it has been revealed to be effective that the magnetic crystal grains are made fine and minute in order to allow the magnetization reversal unit to be fine and minute. However, if the magnetic crystal grains are made excessively minute, the magnetization state of the magnetic crystal grains is thermally unstable, i.e., the so-called thermal demagnetization (thermal signal loss) is caused. In order to avoid this inconvenience, a magnetic recording medium has been disclosed, in which a soft magnetic layer, a first seed layer composed of carbon, a second seed layer, and a recording layer having an artificial lattice structure are successively stacked on a non-magnetic substrate (see, for example, Japanese Patent Application Laid-open No. 8-30951, pages 3 to 5, FIG. 1). In this magnetic recording medium, the second seed layer, which is composed of Pd or Pt, is provided on the first seed layer which is composed of carbon formed on the soft magnetic layer. The artificial lattice film of Co/Pd or Co/Pt is formed thereon. Accordingly, the crystalline orientation of the recording layer is improved, the perpendicular magnetic anisotropy is enhanced, and the coercivity is improved.

Another magnetic recording medium has been disclosed, in which PdBO is used as a seed layer on a substrate, and an artificial lattice film composed of COBO layers and PdBO layers or PtBO layers is used as a recording layer (see, for example, Japanese Patent Application Laid-open No. 2002-25032, pages 3 to 6, FIGS. 2 and 5). Still another magnetic recording medium has been also disclosed, in which PdB-O is used as a seed layer (underlayer) on a substrate, and an artificial lattice film composed of CoB-O layers and PdB-O layers is used as a recording layer (see, for example, Maesaka et al., “TEM Analysis of B, O-added Co/Pd Artificial Lattice Perpendicularly Magnetizable Film”, Abstracts of the 24th Annual Conference on Magnetics in Japan, September 2000, Poster Session, p. 276). Still another magnetic recording medium has been also disclosed, in which Fe—Co—B is used as a soft magnetic layer, Ta/CoCrRu is as a seed layer, and an artificial lattice film composed of CoB layers and Pd layers is used as a recording layer (see, for example, Yukiko Kubota et al., “Effect of non-magnetic interlayer thickness in CoX/Pd multilayer perpendicular media”, North American Perpendicular Magnetic Recording Conference Program, January 2002, Poster Session, p. MP-05).

The artificial lattice multilayer film and the superlattice alloy film, which are usable as the recording layer of the magnetic recording medium, have the high magnetic anisotropy. Therefore, it is expected to exhibit the high resistance against the thermal disturbance. However, the films as described above are different from the polycrystalline film based on Co—Cr, and they have involved the following drawbacks. That is, it is impossible to form small magnetic domains, and the transitional medium noise is increased, because of the strong magnetic interaction in the in-plane direction (direction parallel to the substrate surface) exerted between the crystal grains. For example, in the case of the magnetic recording medium based on the use of the artificial lattice film as the recording layer as disclosed in Japanese Patent Application Laid-open No. 8-30951, the perpendicular magnetic anisotropy can be enhanced to improve the coercivity by improving the crystalline orientation of the artificial lattice film. However, the magnetic exchange coupling force in the in-plane direction, which acts between the crystal grains of the recording layer, is intensified. Therefore, the transition noise, which appears as the jitter when the linear recording density is raised, is increased. There has been such a possibility that it may be difficult to perform the recording and the reproduction at a high recording density. Further, in the case of the magnetic recording medium as disclosed in Japanese Patent Application Laid-open No. 8-30951, the two seed layers, i.e., the first seed layer and the second seed layer are used as the seed layers. Therefore, the film thickness of the entire seed layer is thick. It has been feared that the writing magnetic field, which is applied from the magnetic head, does not arrive at the soft magnetic layer effectively, and the saturation recording characteristics may be deteriorated.

### SUMMARY OF THE INVENTION

A first object of the present invention is to provide a magnetic recording medium which solves the problems involved in the conventional technique as described above, wherein the magnetic exchange coupling force in the in-plane direction acting between crystal grains of a recording layer is lowered, and the transition noise is reduced.

A second object of the present invention is to provide a magnetic storage apparatus which has excellent thermal disturbance resistance characteristics and which makes it possible to reproduce, at high S/N, information recorded at a high surface recording density.

According to a first aspect of the present invention, there is provided a magnetic recording medium comprising a substrate; a soft magnetic layer which is formed on the substrate and which contains B and at least one element selected from the group consisting of Fe, Co, and Ni; a seed layer which is formed adjacently on the soft magnetic layer and which contains B and one of Pd and Pt; and a recording layer which is formed adjacently on the seed layer. According to a second aspect of the present invention, there is provided a magnetic storage apparatus comprising the magnetic recording medium of the first aspect of the present invention; a magnetic head which records or reproduces information; and a drive unit which drives the magnetic recording medium with respect to the magnetic head.

### BRIEF DESCRIPTION OF THE DRAWINGS

FIG. 1 shows a schematic sectional view illustrating a magnetic disk according to the present invention.

FIG. 2 shows a schematic plan view illustrating a magnetic storage apparatus according to the present invention.

FIG. 3 schematically shows a cross-sectional structure of a recording layer of the magnetic disk.

FIG. 4 shows a graph depicting the change of the reproduced signal output obtained with the magnetic disk manufactured in Example 1 with respect to the time.

### DESCRIPTION OF THE PREFERRED EMBODIMENTS

In the magnetic recording medium of the present invention, it is preferable that the soft magnetic layer has a concentration of B of 5 to 30 at. %, and the seed layer has a concentration of B of 20 to 70 at. %. In the magnetic recording medium of the present invention, B is contained in both of the soft magnetic layer and the seed layer to most optimally control the crystalline orientation of the recording layer formed on the seed layer, especially of the recording layer having the artificial lattice structure thereby. In particular, it is preferable that the soft magnetic layer is formed of B and at least one element selected from the group consisting of Fe, Co, and Ni, and the seed layer is formed of an alloy of Pd and B or an alloy of Pt and B. For example, when the soft magnetic layer is formed of Co and B, B is allowed to exist in Co in a segregated manner. Further, when the seed layer is formed of Pd and B on the soft magnetic layer, B contained in the seed layer is presented in Pd in a segregated manner corresponding to the segregated structure of B in the soft magnetic layer. When the recording layer, especially the recording layer having the artificial lattice structure is formed on the seed layer in which B is segregated, then the artificial lattice film is grown with cores of Pd contained in the seed layer, and hence the distinct grain boundary is formed in the recording layer. Accordingly, the magnetic exchange coupling force in the in-plane direction, which acts between the crystal grains, is reduced. Further, the crystalline orientation of the recording layer and the exchange coupling force in the in-plane direction acting between the crystal grains can be optimized by appropriately controlling the ratio between Pd and B in the seed layer. Therefore, in the magnetic recording medium of the present invention, the minute recording magnetic domains can be reliably formed in the recording layer, and the magnetization transition area is distinct as well. Accordingly, it is possible to reduce the noise. That is, the magnetic recording medium of the present invention makes it possible to satisfy both of the contrary characteristics, i.e., the property of low noise and the high resolution.

If any one of the soft magnetic layer and the seed layer does not satisfy the requirement of the present invention, it is difficult to form the minute recording magnetic domains in the recording layer. For example, if the soft magnetic layer is formed of Co and B, and the seed layer is formed of only Pd, then B in the soft magnetic layer is allowed to exist in a segregated manner in Co, but no segregated structure of B is formed in the seed layer. Therefore, it is impossible to grow the recording layer having the distinct crystal grain boundary on the seed layer, and the magnetic exchange coupling force in the in-plane direction, which acts between the crystal grains of the recording layer, is intensified. Therefore, it is difficult to form the minute recording magnetic domains in the recording layer. On the other hand, for example, if the soft magnetic layer is formed of Co—Ta—Zr, and the seed layer is formed of Pd and B, then no segregated structure of B is formed in the soft magnetic layer. Therefore, a sufficiently thick film thickness is required in order to form the segregated structure of B in the seed layer. If the film thickness of the seed layer is thickened, then the gap between the magnetic head and the soft magnetic layer is increased, and the magnetic field, which is directed from the magnetic pole of the magnetic head to the soft magnetic layer, is widened thereby. As a result, the magnetic field is hardly converged onto the recording layer, and it is difficult to form the minute recording magnetic domains in the recording layer.

Further, it is also difficult to form the minute recording magnetic domains in the recording layer if B is not contained in both of the soft magnetic layer and the seed layer. For example, if the soft magnetic layer is formed of a Co—Ta—Zr soft magnetic material, and the seed layer is formed of only Pd crystals, then the segregated structure of B is not formed in both of the soft magnetic layer and the seed layer. Therefore, the recording layer, which has an indistinct crystal grain boundary, is formed on the seed layer, and the magnetic exchange coupling force in the in-plane direction, which acts between the crystal grains of the recording layer, is intensified. Therefore, the recording magnetic domains formed in the recording layer are large-sized, and it is difficult to form the minute recording magnetic domains.

In the magnetic recording medium of the present invention, it is preferable that the seed layer has a film thickness of 1 to 20 nm. If the film thickness of the seed layer is less than 1 nm, the role of the seed layer is insufficient to control the crystalline orientation of the recording layer. On the other hand, if the film thickness of the seed layer is thicker than 20 nm, then the distance between the soft magnetic layer and the magnetic pole of the recording magnetic head is increased, and hence the recording magnetic field, which is applied from the recording magnetic head, is applied in a state of being widened without being converged sufficiently. As a result, it is feared that the resolution may be deteriorated, and the disturbance may be increased in the magnetization transition area, which may cause the noise resulting from those concerning the jitter.

In the magnetic recording medium of the present invention, it is preferable that the recording layer has an artificial lattice structure. The term “artificial lattice structure” herein means the structure which is obtained by stacking a plurality of different substances mutually periodically in a certain direction with thicknesses each corresponding to a single atom or several atoms. The film, which has the artificial lattice structure, is referred to as “artificial lattice film” or “alternately stacked multilayer film” as well. The artificial lattice film as described above can be formed at room temperature or at relatively low substrate temperatures, and the film has the large magnetic anisotropy. Therefore, the artificial lattice film is most appropriate as the recording layer for the high density recording. In the magnetic recording medium of the present invention, it is especially preferable that the artificial lattice structure of the recording layer is a structure in which layers mainly composed of Co and layers mainly composed of Pd are alternately stacked or a structure in which layers mainly composed of Co and layers mainly composed of Pt are alternately stacked.

The recording layer having the artificial lattice structure is preferably an alternately stacked multilayer film which is obtained such that layers mainly composed of Co and layers mainly composed of Pd or Pt are alternately stacked with thicknesses each corresponding to approximately several atoms or an approximately single atom respectively. In particular, it is preferable to use a Co/Pd artificial lattice film or a Co/Pt artificial lattice film obtained by alternately stacking Co layers each having a film thickness selected within a range of 0.05 to 0.5 nm and Pd layers or Pt layers each having a film thickness selected within a range of 0.5 to 2 nm. The perpendicular magnetic anisotropy is most promptly expressed by the artificial lattice film having the film structure as described above.

In the magnetic recording medium of the present invention, it is allowable that an added element is contained in the recording layer formed with the Co/Pd or Co/Pt artificial lattice film. B is especially preferred as the added element, and the concentration of B is preferably 5 to 30 at. %. The method for adding B to the Co/Pd or Co/Pt artificial lattice film includes, for example, a method in which a Co target and a PdB or PtB target are alternately sputtered. When the artificial lattice film is formed while allowing the Pd layer or the Pt layer to contain B as in the formation method as described above, then the composition is fluctuated in the recording layer, and it is possible to reduce the magnetic exchange coupling force in the in-plane direction acting between the crystal grains of the recording layer. When the artificial lattice film is formed by allowing the Pd layer or the Pt layer to contain B, the perpendicular magnetic anisotropy can be suppressed from being lowered as compared with a case in which the artificial lattice film is formed by allowing the Co layer to contain B.

In the magnetic recording medium of the present invention, when the recording layer is formed of the Co/Pd or Co/Pt artificial lattice film, it is preferable that Co is discontinuously distributed in the in-plane direction in the recording layer (Co is studded or dispersed in a form of islands). When Co is distributed discontinuously in the in-plane direction in the artificial lattice film, the magnetic exchange coupling force in the in-plane direction, which acts between the crystal grains, is partially broken. Therefore, it is possible to reduce the magnetic exchange coupling force in the in-plane direction of the recording layer.

In the magnetic recording medium of the present invention, the recording layer formed of the artificial lattice film may be formed of aggregates of columnar (column-shaped) crystal grains having diameters of 2 to 15 nm extending in the direction perpendicular to the surface of the substrate. The tips of the crystal grains are ridged on the surface of the recording layer. The height of the ridge, i.e., the difference between the uppermost portion of the surface of the crystal grain and the lowermost portion of the surface (height position of the boundary between the crystal grains) is preferably 1 to 10 nm. The magnetic exchange coupling force in the in-plane direction, which acts between the crystal grains, is reduced in the recording layer having the structure as described above. Therefore, even when the minute recording magnetic domains are formed in the recording layer, then the recording magnetic domains exist stably, and the linearity of the magnetization transition area is enhanced as well. Therefore, it is possible to further reduce the transition noise during the reproduction.

The recording layer having the artificial lattice structure in the magnetic recording medium of the present invention can be formed as the film by using an ordinary sputtering apparatus. For example, the recording layer can be formed such that two or more targets, which are composed of different materials, are juxtaposed with each other, and the substrate carrier is alternately moved relatively with respect to the respective targets. Alternatively, the recording layer can be also formed as the film as follows. That is, at least two ring-shaped targets having different diameters are coaxially arranged on an identical plane, the substrate is arranged so that the substrate is opposed to the targets, and the ring-shaped targets are alternately subjected to the electric discharge.

It is preferable that the film thickness of the recording layer having the artificial lattice structure is 5 to 60 nm in view of the magnetic characteristics. It is preferable for the recording layer that the coercivity, which is measured in the direction perpendicular to the substrate surface, is 1.5 to 10 kOe (kilboersteds). It is preferable that [Mr·t], which is the product of the film thickness t of the recording layer and the remanent magnetization Mr, is within a range of 0.3 to 1.0 memu/cm². If the coercivity is smaller than 1.5 kOe, it is feared that the output may be decreased when information recorded at a high recording density (not less than 600 kFCI) is reproduced. On the other hand, if the coercivity is smaller than 1.5 kOe, it is feared that the magnetic anisotropy energy may be decreased, and the thermal demagnetization may tend to occur as well. If the value of [Mr·t] is larger than 1.0 memu/cm², the resolution is lowered. If the value of [Mr·t] is smaller than 0.3 memu/cm², the output is excessively decreased. Therefore, it is difficult to obtain sufficient recording and reproduction characteristics when the recording is performed at a high recording density of not less than 200 gigabits/square inch.

As for the substrate of the magnetic recording medium of the present invention, it is possible to use non-magnetic substrates including, for example, aluminum/magnesium alloy substrates, glass substrates, and graphite substrates. The surface of the aluminum/magnesium alloy substrate may be plated with nickel/phosphorus. The substrate surface may be treated to be flat by pressing diamond abrasive grains or an abrasive tape to make abutment against the substrate surface while rotating the substrate. Accordingly, it is possible to improve the traveling characteristic of the magnetic head when the magnetic head is allowed to float over the magnetic recording medium. It is preferable that the center line roughness Ra of the substrate surface is regulated so that the center line roughness of the protective layer formed on the substrate is not more than 1 nm. In the case of the glass substrate, the surface may be chemically etched to be flat with any chemical such as strong acid. When minute heights, for example, projections of not more than 1 nm are chemically formed on the surface, it is possible to realize a stable low floating amount when the negative pressure slider is used.

An adhesive layer, which is composed of Ti or the like, may be formed between the soft magnetic layer and the substrate of the magnetic recording medium of the present invention in order to improve the adhesion between the substrate and the soft magnetic layer.

The magnetic recording medium of the present invention may be provided with a protective layer on the recording layer. As for the protective layer, for example, it is possible to preferably use any one of amorphous carbon, silicon-containing amorphous carbon, nitrogen-containing amorphous carbon, boron-containing amorphous carbon, silicon oxide, zirconium oxide, and cubic system boron nitride. The method for forming the protective layer composed of amorphous carbon as described above includes, for example, a method in which the protective layer is formed by the sputtering in an inert gas or in a mixed gas of an inert gas and a hydrocarbon gas such as methane by using a target of graphite, a method in which the protective layer is formed by means of the plasma CVD by using an organic compound such as hydrocarbon gas, alcohol, acetone, or adamantane singly or mixed with, for example, hydrogen gas or an inert gas, and a method in which the protective layer is formed by ionizing an organic compound and effecting the acceleration by applying a voltage to make collision with the substrate. Alternatively, the protective layer may be formed by the ablation method in which a high output laser is collected with a lens to effect the radiation onto a target such as graphite.

A lubricant may be applied onto the protective layer in order to obtain satisfactory sliding movement resistance characteristics. As for the lubricant, it is possible to use a perfluoropolyether-based polymer lubricant having a principal chain structure composed of three elements, i.e., carbon, fluorine, and oxygen. Alternatively, a fluorine-substituted alkyl compound can be also used as the lubricant. Other organic lubricants or inorganic lubricants may be used provided that they are materials which provide stable sliding movement and durability.

The solution-applying method is generally adopted as the method for forming the lubricant film as described above. In order to avoid the global warming or in order to simplify the steps, the lubricant film may be formed by means of the photo-CVD method in which no solvent is used. The photo-CVD method is carried out by irradiating gaseous raw materials of olefin fluoride and oxygen with the ultraviolet light.

The film thickness of the lubricant film is appropriately 0.5 to 3 nm in average value. If the film thickness is thinner than 0.5 nm, the lubricating characteristic is lowered. If the film thickness is thicker than 3 nm, then the meniscus force is increased, and the static frictional force (stiction) between the magnetic head and the magnetic disk is increased, which is not preferred. The heat may be applied at about 100° C. for 1 to 2 hours in nitrogen or in air after forming the lubricant film. Accordingly, any excessive solvent and low molecular weight components can be evaporated to improve the adhesion between the lubricant film and the protective layer. Other than the aftertreatment as described above, for example, it is also allowable to use a method in which the ultraviolet light is radiated with an ultraviolet lamp for a short period of time after forming the lubricant film. The same or equivalent effect is also obtained by means of this method.

According to the second aspect of the present invention, there is provided a magnetic storage apparatus comprising the magnetic recording medium as defined in the first aspect of the present invention; a magnetic head which is operable to record or reproduce information; and a drive unit which is operable to drive the magnetic recording medium with respect to the magnetic head.

The magnetic storage apparatus of the present invention is provided with the magnetic recording medium according to the first aspect of the present invention. Therefore, information can be recorded at a high surface recording density, and the information can be reproduced at a high S/N. Further, the magnetic storage apparatus of the present invention also provided with excellent thermal disturbance resistance characteristics.

In the magnetic storage apparatus of the present invention, the magnetic head may comprise a recording magnetic head for recording information on the magnetic recording medium, and a reproducing magnetic head for reproducing the recorded information on the magnetic recording medium. It is preferable that the recording magnetic head has a gap length of 0.2 to 0.02 μm. If the gap length exceeds 0.2 μm, it is difficult to perform the recording at high linear recording densities of not less than 400 kFCI. On the other hand, it is difficult to produce a recording head having a gap length smaller than 0.02 μm. In the case of such a recording head, the device destruction tends to occur due to any induction of static electricity.

It is preferable that the reproducing magnetic head is constructed with a magnetoresistance effect element. It is preferable that the reproducing magnetic head has a reproduction shield spacing of 0.2 to 0.02 μm. The reproduction shield spacing directly relates to the reproduction resolution. The shorter the reproduction shield spacing is, the higher the resolution is. It is preferable that the lower limit value of the reproduction shield spacing is appropriately selected within the range described above depending on, for example, the stability of the element, the reliability, the electricity resistance characteristic, and the output.

In the magnetic storage apparatus of the present invention, the drive unit can be constructed by using a spindle which drives and rotates the magnetic recording medium. The velocity of revolution of the spindle is preferably 3,000 to 20,000 revolutions per minute. If the velocity of revolution is slower than 3,000 revolutions per minute, the data transfer speed is lowered, which is not preferred. If the velocity of revolution exceeds 20,000 revolutions per minute, the noise and the heat generated from the spindle are increased, which is not preferred. Taking the velocity of revolution as described above into consideration, the optimum relative velocity between the magnetic recording medium and the magnetic head is 2 to 30 m/second.

### EXAMPLES

An explanation will be made specifically with reference to the drawings about Examples of the magnetic recording medium according to the present invention and the magnetic storage apparatus based on the use of the same. However, the present invention is not limited thereto. The present invention may include a variety of modified embodiments and improved embodiments. In Examples described below, magnetic disks (hard disks) were manufactured as the magnetic recording media. However, the present invention is also applicable to recording media of the type in which the magnetic head and the magnetic recording medium make contact during the recording or the reproduction, including, for example, flexible disks, magnetic tapes, and magnetic cards.

### Example 1

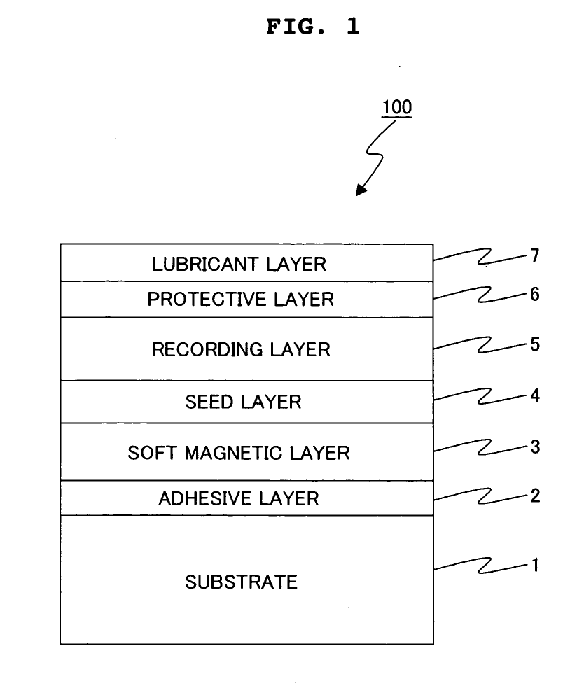

FIG. 1 shows a schematic sectional view illustrating a magnetic disk manufactured in Example 1. As shown in FIG. 1, the magnetic disk 100 has a structure obtained by successively stacking an adhesive layer 2, a soft magnetic layer 3, a seed layer 4, a recording layer 5, a protective layer 6, and a lubricant layer 7 on a substrate 1. The magnetic disk 100 having the stacked structure was produced in accordance with the following method.

At first, the glass substrate 1 having a diameter of 65 mm was prepared. A Ti film was formed as the adhesive layer 2 to have a film thickness of 5 nm on the glass substrate 1 by using a continuous sputtering apparatus.

Subsequently, a film of Co₈₅B₁₅ (at. %) was formed as the soft magnetic layer 3 to have a film thickness of 200 nm on the adhesive layer 2. When the soft magnetic layer 3 was formed, the DC sputtering was performed by using a CoB alloy target while introducing Ar gas into a chamber.

Subsequently, a film of Pd₆₆B₃₄ (at. %) was formed as the seed layer 4 to have a film thickness of 4 nm on the soft magnetic layer 3. When the seed layer 4 was formed, the DC sputtering was performed by using a PdB alloy target while introducing Kr gas into the chamber.

Subsequently, a film of the recording layer 5 having an artificial lattice structure was formed on the seed layer 4. When the recording layer 5 was formed, the DC sputtering was performed while alternately effecting the electric discharge with a Co target and a Pd₈₅B₁₅ (at. %) target in Kr gas to form the recording layer 5 having the artificial lattice structure in which Co layers and PdB layers were alternately stacked. One layer of the Co layers had a film thickness of 0.14 nm, and one layer of the PdB layers had a film thickness of 0.94 nm. As for the stacking numbers of the PdB layers and the Co layers, the number of the PdB layers was 25, and the number of the Co layers was 25.

Subsequently, amorphous carbon was formed as the protective layer 6 to have a film thickness of 3 nm on the recording layer 5 by the plasma CVD method. After the formation of the protective layer 6, the substrate was taken out from the film formation apparatus. Finally, the lubricant layer 7 was formed by dipping in a lubricant solution based on perfluoropolyether to have a thickness of 1 nm on the protective layer 6.

Thus, the magnetic disk 100 having the stacked structure as shown in FIG. 1 was manufactured.

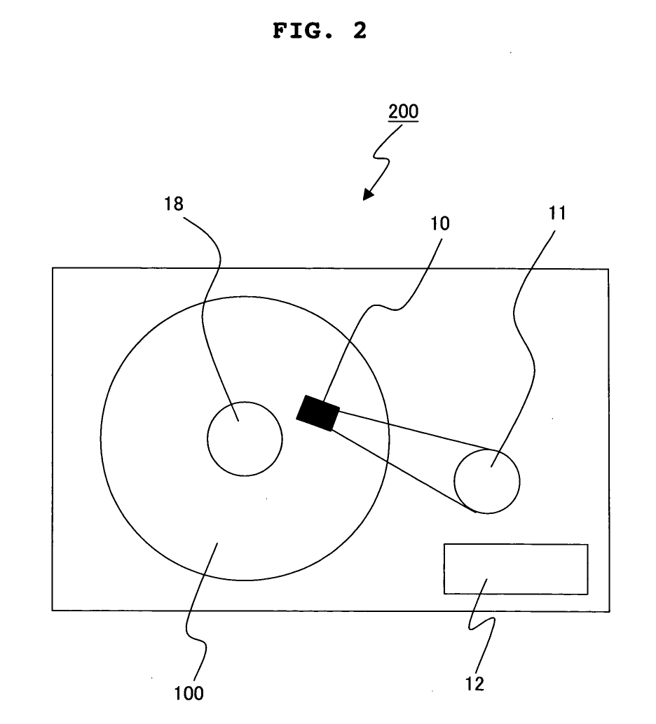

Subsequently, the magnetic disk 100 manufactured in Example 1 was incorporated into a magnetic storage apparatus 200 having a planar structure as schematically shown in FIG. 2. As shown in FIG. 2, the magnetic storage apparatus 200 comprises the magnetic disk 100, a rotary driving section 18 for driving and rotating the magnetic disk 100, a magnetic head 10, a head drive unit 11 for moving the magnetic head 10 to a desired position over the magnetic disk 100, and a recording/reproduction signal-processing unit 12.

The magnetic head 10 includes a single magnetic pole type writing element and a GMR (Giant Magneto-Resistive) reading element. The magnetic head 10 is provided at the tip of an arm of the head drive unit 11. The single magnetic pole type writing element of the magnetic head 10 is capable of recording information on the magnetic disk 100 by applying a magnetic field corresponding to data to be recorded during the recording of information to the magnetic disk 100. The GMR reading element of the magnetic head 10 is capable of reproducing information recorded on the magnetic disk 100 by detecting the change of the leak magnetic field from the magnetic disk 100.

The recording/reproduction signal-processing unit 12 is capable of sending the recording signal to the single magnetic pole type writing element of the magnetic head 10 by encoding data to be recorded on the magnetic disk 100. Further, the recording/reproduction signal-processing unit 12 is capable of decoding the reproduced signal obtained from the magnetic disk 100 detected by the GMR reading element of the magnetic head 10.

Measurement of S/N and Coercivity

The magnetic storage apparatus 200 was driven to record information on the magnetic disk 100 under a condition of a linear recording density of 1000 kBPI and a track density of 200 kTPI while maintaining the magnetic spacing (distance between the main magnetic pole surface of the magnetic head 10 and the recording layer surface of the magnetic disk 100) to be 13 nm. Subsequently, the recorded information was reproduced to evaluate the recording and reproduction characteristic. As a result, a value of 24.5 dB was obtained as total S/N. Accordingly, it has been revealed that even the information recorded at the high recording density of a surface recording density of 200 gigabits/square inch can be reproduced at high S/N on the magnetic disk 100 manufactured in Example 1. The total S/N was determined in accordance with S/N=20 log (S₀₋ₚ/Nᵣₘₛ). In the expression, S₀₋₉ represents the value which is a half of the reproduced signal amplitude as ranging from the zero point to the peak (zero to peak), and Nᵣₘₛ represents the root-mean-square value of the amplitude of the noise measured with a spectrum analyzer. Further, the magnetic characteristics of the magnetic disk 100 manufactured in Example 1 in the direction perpendicular to the film surface of the recording layer were measured. As a result, the saturation magnetization was 154 emu/cc, and the coercivity was 3.8 koe.

Head Seek Test

The following head seek test was performed. That is, the magnetic head 10 of the magnetic storage apparatus 200 was subjected to the seek one hundred thousand times from the inner circumference to the outer circumference over the magnetic disk 100 manufactured in Example 1. The bit errors of the magnetic disk 100 were measured after the head seek test. As a result, the number of bit errors was not more than 10 bits/surface. Further, an average time interval between failures of three hundred thousand hours was successfully achieved.

Measurement of Electromagnetic Conversion Characteristics

Subsequently, the electromagnetic conversion characteristics of the magnetic disk manufactured in Example 1 were measured by using a spin-stand playback test machine (not shown). A composite type head composed of a single magnetic pole type writing element and a GMR reading element was used as the magnetic head of the playback test machine. As for the main pole (main magnetic pole) of the single magnetic pole type writing element, the effective writing track width was 110 nm, and the saturation magnetic flux density Bs was 2.1 T. As for the GMR reading element, the effective track width was 97 nm, and the shield spacing was 45 nm. When the playback test was performed, the spacing distance was 13 nm between the main magnetic pole surface of the single magnetic pole type writing element of the magnetic head and the recording layer surface of the magnetic disk.

The following results were obtained in the measurement of the electromagnetic conversion characteristics performed for the magnetic disk manufactured in Example 1. That is, S/Nd was 24.6 dB to represent the signal-to-noise ratio at a linear recording density of 450 kFCI, and Re was 29.9% to represent the output resolution obtained by dividing the reproduction output at a linear recording density of 300 kFCI by the isolated read signal output.

Observation of Cross-Sectional Structure of Recording Layer

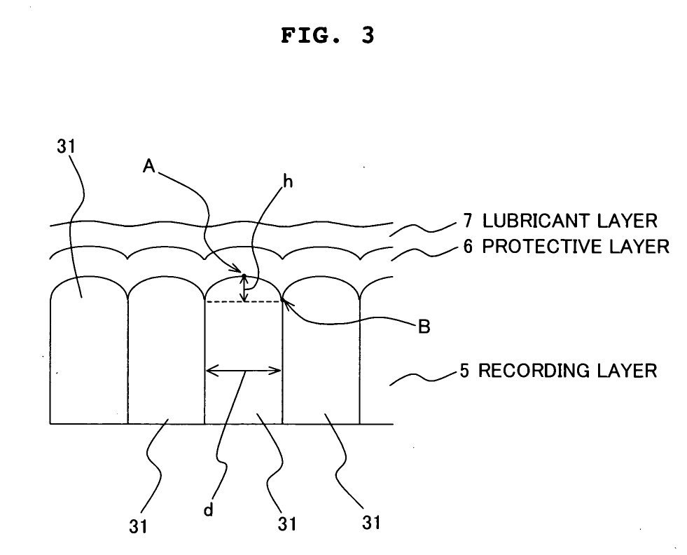

Subsequently, the cross-sectional structure of the magnetic disk manufactured in Example 1 was observed with a high resolution transmission electron microscope. FIG. 3 schematically shows a result of the observation of the cross-sectional structure of the recording layer 5 formed with the artificial lattice structure. As shown in FIG. 3, the recording layer 5 was composed of aggregates of columnar crystal grains 31. The upper surface of each of the crystal grains 31 was hemispherical. The diameter d of the crystal grain was about 8 nm. The difference h between the uppermost portion A and the lowermost portion B of the hemispherical part disposed at the upper surface of the crystal grain was 2 nm. It is considered that the magnetic coupling force in the in-plane direction acting between the crystal grains is reduced, the minute recording bits are stabilized, and the linearity of the magnetization transition area is improved, because the recording layer 5 is composed of the columnar crystal grains as shown in FIG. 3.

Measurement of Thermal Demagnetization Ratio

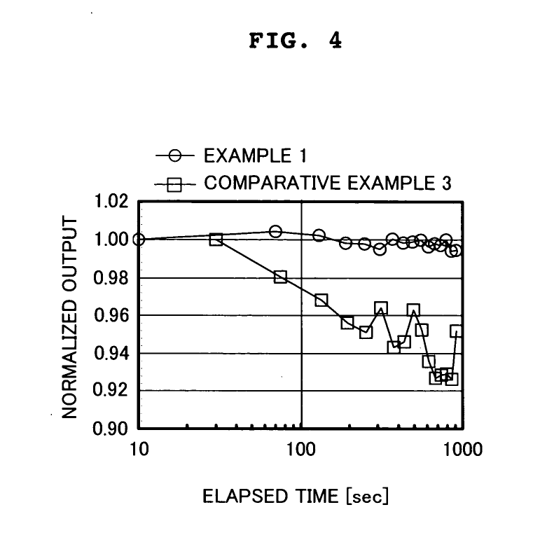

Subsequently, the thermal demagnetization ratio was measured for the magnetic disk manufactured in Example 1. The thermal demagnetization ratio represents the ratio of the time-dependent change of the reproduced signal amplitude obtained when a signal, which is recorded at a linear recording density of 100 kFCI, was reproduced in an environment at 24° C. FIG. 4 shows a result of the measurement of the thermal demagnetization ratio. FIG. 4 also shows a result of Comparative Example 3 as described later on. As shown in FIG. 4, it has been revealed that the normalized output is scarcely decreased even when the time elapses, and no thermal demagnetization occurs in the case of the magnetic disk of Example 1, probably for the following reason. That is, it is considered that the magnetization transition area of the recording layer of the magnetic disk manufactured in Example 1 is distinct, and the linearity is high. The error rate was measured on-track at a linear recording density of 1000 kBPI. As a result, the error rate was not more than 1×10^{-5.}

### Comparative Example 1

In Comparative Example 1, a magnetic disk was manufactured, in which B was added to the seed layer, and B was not contained in the soft magnetic layer. As for the magnetic disk manufactured in Comparative Example 1, the magnetic disk was manufactured in the same manner as in Example 1 except that the soft magnetic layer was formed of a Co—Ta—Zr soft magnetic material, and the concentration of B of the seed layer was 22 at. %. The magnetic characteristics were measured in the direction perpendicular to the film surface of the recording layer of the magnetic disk manufactured in Comparative Example 1. As a result, the saturation magnetization was 195 emu/cc, and the coercivity was 3.8 koe.

The electromagnetic conversion characteristics were measured for the magnetic disk manufactured in Comparative Example 1 in the same manner as in Example 1. Results of the measurement are shown in Table 1. Results of the measurement of the electromagnetic conversion characteristics of Example 1, Examples 2 to 5, and Comparative Example 2 as described later on are also shown in Table 1 together, in addition to the results of the measurement obtained in Comparative Example 1. As clarified from Table 1, S/Nd=18.2 dB and Re=27.1% were obtained for the magnetic disk manufactured in Comparative Example 1. Example 1 is compared with Comparative Example 1 as follows. That is, the higher values were obtained for the magnetic disk manufactured in Example 1 by 6.4 dB for S/Nd and by 2.8% for Re. According to these results, it has been revealed that the transition noise is reduced even in higher regions, and both of the high resolution and the high S/N are satisfied in the case of the magnetic disk manufactured in Example 1 as compared with the magnetic disk manufactured in Comparative Example 1.

TABLE 1

| | | | | | | | Magnetic | | | |
|---|---|---|---|---|---|---|---|---|---|---|
| | | | | | | | characterisitics of | | | |
| | | | | | | | recording layer | | Electro- | |
| | Condition of soft | | | | | | (perpendicular | | magnetic | |
| | magnetic layer | | | Condition of seed layer | | | components) | | conversion | |
| | | B | Film | | B | Film | Saturation | | measurement | |
| | | concentration | thickness | | concetration | thickness | magnetization | Coercivity | Re | S/Nd |
| Contents | Type | [at. %] | [nm] | Type | [at. %] | [nm] | [emu/cc] | [kOe] | [%] | [dB] |
| Example 1 | Co-B | 15 | 200 | pd-B | 34 | 4 | 154 | 3.8 | 29.9 | 24.6 |
| Example 2 | Fe-B | 18 | 200 | Pd-B | 39 | 4 | 142 | 3.5 | 30.0 | 24.5 |
| Example 3 | Fe-Co-B | 7 | 200 | Pd-B | 32 | 4 | 168 | 4.2 | 29.0 | 24.2 |
| Example 4 | Ni-Fe-B | 4 | 200 | Pd-B | 37 | 4 | 165 | 4.1 | 28.8 | 23.9 |
| Example 5 | Co-B | 15 | 200 | Pt-B | 24 | 4 | 206 | 6.0 | 27.5 | 22.4 |
| Comp. Ex. 1 | Co-Ta-Zr | 0 | 200 | Pd-B | 22 | 4 | 195 | 3.8 | 27.1 | 18.2 |
| Comp. Ex. 2 | Co-B | 15 | 200 | Pd | 0 | 4 | 250 | 3.9 | 24.0 | 15.9 |

### Comparative Example 2

In Comparative Example 2, a magnetic disk was manufactured, in which B was added to the soft magnetic layer, and B was not contained in the seed layer. As for the magnetic disk manufactured in Comparative Example 2, the magnetic disk was manufactured in the same manner as in Example 1 except that the seed layer was formed of Pd. The magnetic characteristics were measured in the direction perpendicular to the film surface of the recording layer of the magnetic disk manufactured in Comparative Example 2. As a result, the saturation magnetization was 250 emu/cc, and the coercivity was 3.9 koe.

The electromagnetic conversion characteristics were measured for the magnetic disk manufactured in Comparative Example 2 in the same manner as in Example 1. Results of the measurement are shown in Table 1. As clarified from Table 1, S/Nd=15.9 dB and Re=24.0% were obtained for the magnetic disk manufactured in Comparative Example 2. Example 1 is compared with Comparative Example 2 as follows. That is, the higher values were obtained for the magnetic disk manufactured in Example 1 by 8.7 dB for S/Nd and by 5.9% for Re. According to these results, it has been revealed that the transition noise is reduced even in higher regions, and both of the high resolution and the high S/N are satisfied in the case of the magnetic disk manufactured in Example 1 according to the present invention as compared with the magnetic disk manufactured in Comparative Example 2.

### Comparative Example 3

In Comparative Example 3, a magnetic disk was manufactured in the same manner as in Example 1 except that the recording layer was formed of a polycrystalline material based on Co—Cr without using the artificial lattice film.

The thermal demagnetization ratio was measured for the magnetic disk manufactured in Comparative Example 3 in the same manner as in Example 1. Results of the measurement are shown in FIG. 4. As clarified from FIG. 4, the following fact is appreciated. That is, the normalized output was lowered in accordance with the elapse of time in the case of the magnetic disk manufactured in Comparative Example 3. On the contrary, the normalized output was scarcely lowered even when the time elapsed in the case of the magnetic disk manufactured in Example 1, in which the thermal demagnetization was not caused. These results were obtained probably for the following reason. That is, it is considered that the magnetization transition area of the recording layer of the magnetic disk manufactured in Example 1 is distinct, and the linearity is high.

### Example 2

In Example 2, a magnetic disk was manufactured in the same manner as in Example 1 except that the soft magnetic layer was formed of Fe₈₂B₁₈, and the concentration of B of the seed layer was 39 at. %. The magnetic characteristics were measured in the direction perpendicular to the film surface of the recording layer of the magnetic disk manufactured in Example 2. As a result, the saturation magnetization was 142 emu/cc, and the coercivity was 3.5 koe.

The electromagnetic conversion characteristics were measured for the magnetic disk manufactured in Example 2 in the same manner as in Example 1. As a result of the measurement, S/Nd=24.5 dB and Re=30.0% were obtained. As clarified from Table 1, the satisfactory results were obtained for both of S/Nd and Re as compared with the magnetic disks manufactured in Comparative Examples 1 and 2.

### Example 3

In Example 3, a magnetic disk was manufactured in the same manner as in Example 1 except that the soft magnetic layer was formed of Fe₆₅Co₂₈B₇, and the concentration of B of the seed layer was 32 at. %. The magnetic characteristics were measured in the direction perpendicular to the film surface of the recording layer of the magnetic disk manufactured in Example 3. As a result, the saturation magnetization was 168 emu/cc, and the coercivity was 4.2 kOe.

The electromagnetic conversion characteristics were measured for the magnetic disk manufactured in Example 3 in the same manner as in Example 1. As a result of the measurement, S/Nd=24.2 dB and Re=29.0% were obtained. As clarified from Table 1, the satisfactory results were obtained for both of S/Nd and Re as compared with the magnetic disks manufactured in Comparative Examples 1 and 2.

### Example 4

In Example 4, a magnetic disk was manufactured in the same manner as in Example 1 except that the soft magnetic layer was formed of Ni₇₉Fe₁₇B₄, and the concentration of B of the seed layer was 37 at. %. The magnetic characteristics were measured in the direction perpendicular to the film surface of the recording layer of the magnetic disk manufactured in Example 4. As a result, the saturation magnetization was 165 emu/cc, and the coercivity was 4.1 koe.

The electromagnetic conversion characteristics were measured for the magnetic disk manufactured in Example 4 in the same manner as in Example 1. As a result of the measurement, S/Nd=23.9 dB and Re=28.8% were obtained. As clarified from Table 1, the satisfactory results were obtained for both of S/Nd and Re as compared with the magnetic disks manufactured in Comparative Examples 1 and 2.

### Example 5

In Example 5, a magnetic disk was manufactured in the same manner as in Example 1 except that the seed layer was formed of Pt₇₆B₂₄. The magnetic characteristics were measured in the direction perpendicular to the film surface of the recording layer of the magnetic disk manufactured in Example 5. As a result, the saturation magnetization was 206 emu/cc, and the coercivity was 6.0 koe.

The electromagnetic conversion characteristics were measured for the magnetic disk manufactured in Example 5 in the same manner as in Example 1. As a result of the measurement, S/Nd=22.4 dB and Re=27.5% were obtained. As clarified from Table 1, the satisfactory results were obtained for both of S/Nd and Re as compared with the magnetic disks manufactured in Comparative Examples 1 and 2.

The magnetic recording medium of the present invention comprises the soft magnetic layer which is formed of the alloy containing B and at least one of Fe, Co, and Ni, and the seed layer which is formed of the alloy containing B and Pd or Pt, as the underlayers for the recording layer having the artificial lattice structure. Therefore, the distinct crystal grain boundary is formed in the recording layer, and it is possible to reduce the magnetic coupling force in the in-plane direction of the recording layer. Accordingly, the disturbance of the magnetization transition area of the recording layer is reduced. Therefore, information can be reproduced with low medium noise even when the linear recording density is raised. Further, the magnetic recording medium of the present invention has the high thermal stability, because of the use of the artificial lattice film having the high magnetic anisotropy as the recording layer.

The magnetic storage apparatus of the present invention is provided with the magnetic recording medium of the present invention. Therefore, even when information is recorded at a high surface recording density of 200 gigabits/square inch (about 31 gigabits/square centimeter), the information can be reproduced at high S/N. Further, the magnetic storage apparatus of the present invention has the high thermal demagnetization resistance characteristic.

What is claimed is:

1. A magnetic recording medium comprising:
a substrate;
a soft magnetic layer which is formed on the substrate and which contains B and at least one element selected from the group consisting of Fe, Co, and Ni;
a seed layer which is formed adjacently on the soft magnetic layer and which contains B and one of Pd and Pt; and
a recording layer which is formed adjacently on the seed layer.

2. The magnetic recording medium according to claim 1, wherein the soft magnetic layer has a concentration of B of 5 to 30 at. %, and the seed layer has a concentration of B of 20 to 70 at. %.

3. The magnetic recording medium according to claim 1, wherein the seed layer has a film thickness of 1 to 20 nm.

4. The magnetic recording medium according to claim 1, wherein the recording layer has an artificial lattice structure.

5. The magnetic recording medium according to claim 4, wherein the artificial lattice structure of the recording layer is a structure in which layers mainly composed of Co and layers mainly composed of Pd are alternately stacked or a structure in which layers mainly composed of Co and layers mainly composed of Pt are alternately stacked.

6. The magnetic recording medium according to claim 5, wherein the recording layer contains B.

7. The magnetic recording medium according to claim 6, wherein a concentration of B in the recording layer is 5 to 30 at. %.

8. The magnetic recording medium according to claim 5, wherein the layer mainly composed of Co included in the recording layer has a film thickness of 0.05 to 0.5 nm, and the layer mainly composed of Pd or Pt has a film thickness of 0.5 to 2 nm.

9. The magnetic recording medium according to claim 1, wherein the recording layer is composed of aggregates of columnar crystal grains having diameters of 2 to 15 nm.

10. A magnetic storage apparatus comprising:
the magnetic recording medium as defined in claim 1;
a magnetic head which records or reproduces information; and
a drive unit which drives the magnetic recording medium with respect to the magnetic head.

11. The magnetic storage apparatus according to claim 10, wherein the magnetic head includes a magnetoresistance effect type magnetic head.
